(19) United States
(12) Patent Application Publication
(10) Pub. No.: US 2004/0182275 A1
(43) Pub. Date: Sep. 23, 2004

(54) Guideway for Maglev transportation system and method for assembly

(76) Inventors: Karl H. Frank, Austin, TX (US); Billy C. Lannom, Chico, TX (US); David L. Hirschfeld, San Angelo, TX (US); Wendall W. Hirschfeld, Austin, TX (US)

Correspondence Address: EDWARD A SOKOLSKI, 3868 CARSON STREET, 105, TORRANCE, CA, 90503, US

(21) Appl. No.: 10/805,545

(22) Filed: Mar. 20, 2004

Related U.S. Application Data
(60) Provisional application No. 60/456,607, filed on Mar. 20, 2003.

(51) Int. Cl. B60L 13/00

(52) U.S. Cl. 104/286

(57) ABSTRACT

Functional elements in a railway track are supported on structural elements supported on the ground. Electromagnetic circuitry on a railroad operates in conjunction with the functional elements to provide electromagnetic levitation and drive for the railroad. The functional elements are fabricated in relatively small sections, approximately six meters in length. The structural elements, which support the functional elements and the functional elements are fabricated separately and shipped separately to the site of the railway track where they are assembled together to form the support for the railroad. Adjustment members are provided on the functional and structural elements to enable vertical and lateral positional adjustment between the two elements,

This invention relates to a Maglev transportation system and more particularly to the guideway or track system for such a system. This application is based on Provisional Application, Serial No., 60/456,607 filed Mar. 20, 2003.

### BACKGROUND OF THE INVENTION

Maglev transportation systems are experimentally being used in Germany, China and other countries and are described in U.S. Pat. No. 6,357,359 issued May 19, 2002 to Davey, et al. and U.S. Pat. No. 5,628,253 issued May 13, 1997 to Ozeki, et al. as well as other patents. In these systems electromagnetic levitation and drive for the vehicle is provided by electromagnetic circuitry on the vehicle which operates in conjunction with circuitry in “functional” elements on the guide or track. The functional elements are supported by structural elements, the two units being integrated into a single assembly which is mounted on pilings supported on the ground. The vehicles of such systems have been run up to speeds of 310 mph.

In such prior art systems, the length of each section of functional and structural elements is between 24 and 62 meters. The structural elements are generally monolithic in structure. The functional elements involve electrical components and therefore are fabricated to narrow tolerances by a manufacturer involved with high tech electrical design and fabrication. The two sets of units are fabricated and assembled together by the same manufacturer as a single unit and then delivered to the construction site as integral assemblies where they are adjusted to alignment by means of bearings on the pilings. The fabrication of the two units as an integral assembly by the same manufacturer as well as the delivery of these large size composite units poses significant problems as does the installation of these long and heavy assemblies in the field. The use of the same manufacturer for fabricating both the functional and structural elements is not optimum in that the same manufacturer generally does not have high capability in both structural and electronic design. Further, the lateral and vertical adjustment of the assemblies by adjusting the pilings is a more difficult task than to be desired.

### SUMMARY OF THE INVENTION

The present invention overcomes these shortcomings by fabricating the functional units as modules which are 6-12 meters in length The functional elements, which have narrow tolerances and involve high tech manufacturing, are separately manufactured and shipped from their manufacturers to the installation site and attached at this location to longer structural elements, which have common less stringent tolerances. The structural elements are separately shipped to the installation site rather than being integrated with the functional elements. This alleviates problems encountered in the prior art in shipment and makes for less cumbersome handling. The two elements are joined together in a manner so that they can readily be precisely adjusted relative to each other both vertically and laterally after installation, this end result being achieved by adjustable attachments. This alleviates problems encountered in the prior art in final assembly and alignment. The structural element fabricator can work independently of the functional element fabricator and can deliver his product directly to the site. He thus is more in a position to provide flexible economical architectural designs and can design the structural elements in a more efficient manner.

### BRIEF DESCRIPTION OF THE DRAWINGS

FIG. 1 are a perspective view of a typical Maglev railroad system;

FIG. 2 is an exploded schematic view of prior art support and functional elements of a Maglev system;

FIG. 3 is an exploded schematic view of the support and functional elements of the system of the invention;

FIG. 4 is an end elevational view showing the support and structural elements supported on the ground, one view showing the railroad supported on the elements and the other showing only the elements;

FIG. 5 is a cross sectional view of the functional element of the preferred embodiment;

FIG. 6 is a cross sectional view of the structural element of the preferred embodiment;

FIG. 7 is a side elevational view of the functional element of the preferred embodiment;

FIG. 8 is a side elevational view of the structural element of the preferred embodiment;

FIG. 9 is a side elevational view showing the structural and functional elements of FIGS. 7 and 8 connected together;

FIG. 10 is an exploded side elevational view illustrating an alternate adjustable attachment between the structural and functional elements; and

FIG. 11 is a side elevational view showing the adjustable attachment of FIG. 10 assembled.

### DETAILED DESCRIPTION OF THE INVENTION

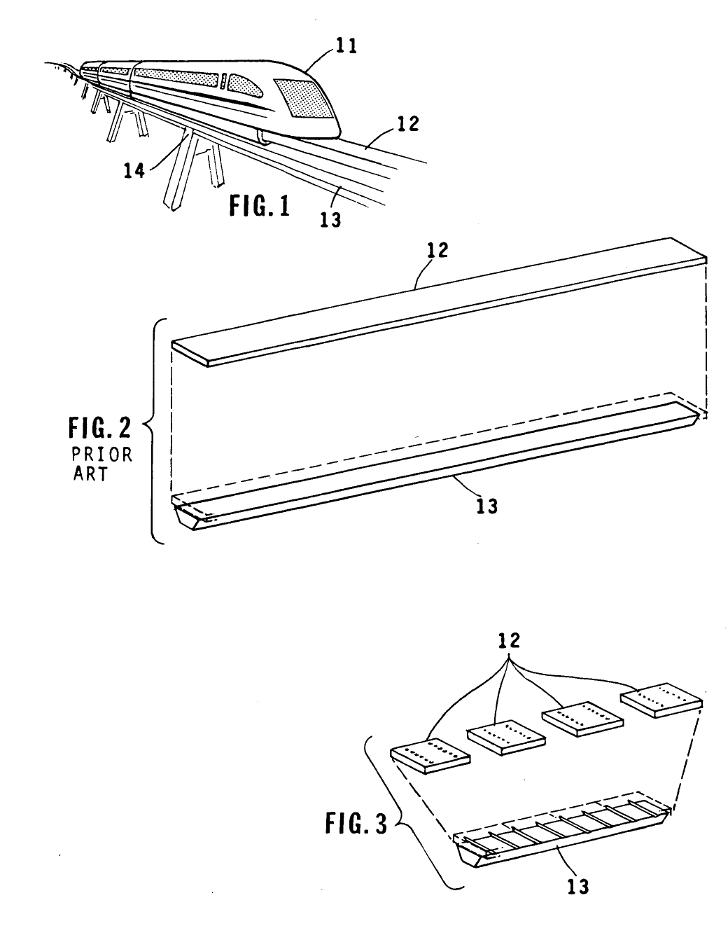

Referring to FIG. 1 a typical Maglev railroad 11 is shown magnetically levitated and driven by an electromagnetic system in functional element 12 which operates in conjunction with electromagnetic components of the system on the railroad. The functional elements are supported on structural elements 13 which are supported on pillars 14 on the ground. FIG. 2 schematically illustrates a typical prior art system. In such systems, the functional elements 13 are generally between 24 and 62 meters in length and the structural elements 13 of the same length. In the prior art, the entire assembly including the functional and structural elements are integrated into a single assembly in manufacture and shipped to the track construction site fully assembled. As each unit is 24 meters in length or longer, this presents problems in manufacture, shipping to the constructions site and assembly at the construction site.

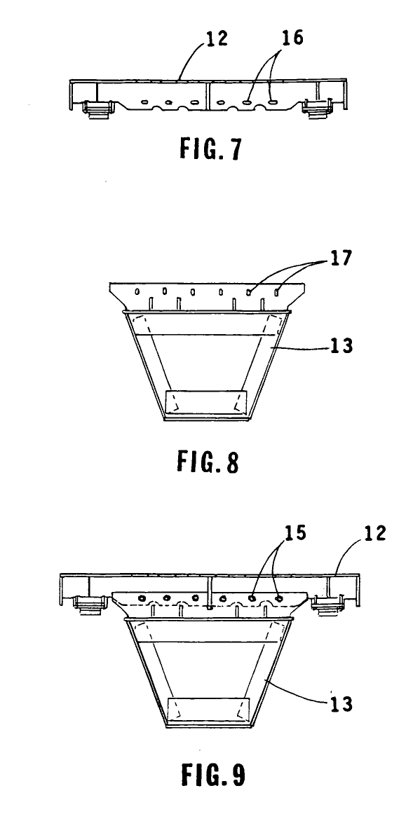

Referring to FIG. 3 the device of the present invention is schematically illustrated. The length of the functional elements 12 is of the order of 6-12 meters. The two elements are separately manufactured and separately shipped to the construction site for assembly and installation. The structural elements are typically of the order of 24 meters so that four functional elements of 6 meters can be attached to each structural element. The functional element is shown in FIG. 7 and the structural element in FIG. 8. The two elements are shown assembled together in FIG. 9. The functional elements are connected to the structural elements by means of bolts 15 installed through holes 16 and 17 formed in the functional and structural elements. In the embodiment shown, the functional element has horizontal holes 16 formed therein and the structural element has vertical holes 17 to allow for horizontal and vertical adjustment in installation. The two elements are joined together by bolts such as huck bolts 15 which pass through the holes. The holes 17 extend vertically a distance substantially greater than the diameter of bolts 15 while holes 16 extend horizontally a distance substantially greater than the diameter of the bolts. This permits alignment of the elements on installation.

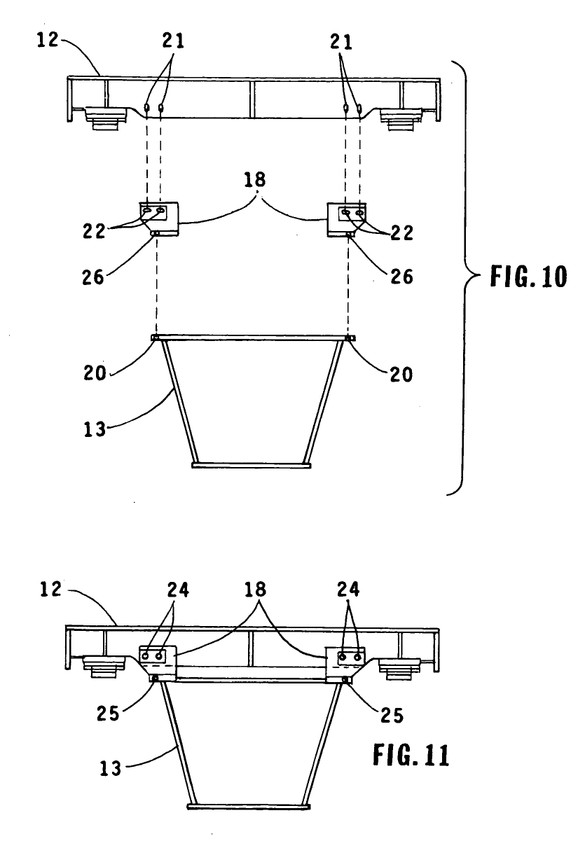

FIGS. 10 and 11 illustrate an alternative method for adjustably connecting the functional and structural elements to each other.

Brackets 18 are used to attach the two elements together. Vertically oriented elongated apertures 21 are formed in functional element 12. Horizontally oriented elongated apertures 22 are formed in the forward portion of the brackets which is attached to functional element 12. Bolts 24 pass through horizontally elongated apertures 22 in the forward portion of the brackets and through the vertically oriented elongated apertures 21 formed in the functional element. Bolts 25 pass through apertures 26 formed in the rear of the bracket and holes 20 in the top portion of the structural element 13. Thus, the relative positions both vertically and laterally between the structural and functional elements can be adjusted and then tightened together by means of the bolts 24 and 25.

The fabrication of the two substantially shorter elements separately and their separate shipment to the installation site, where they are assembled, greatly facilitates manufacture, shipment and assembly.

The functional element employed in the present invention is a typical such unit now in use, as illustrated in FIG. 5. A guidance rail 18 wraps around the base of the train. An electromagnetic stator pack 19 is contained within the functional element and operates in conjunction with an electromagnetic control on the train to magnetically levitate the train off the structural element and to propel the train.

FIG. 6 illustrates a typical steel support element for supporting functional element 13.

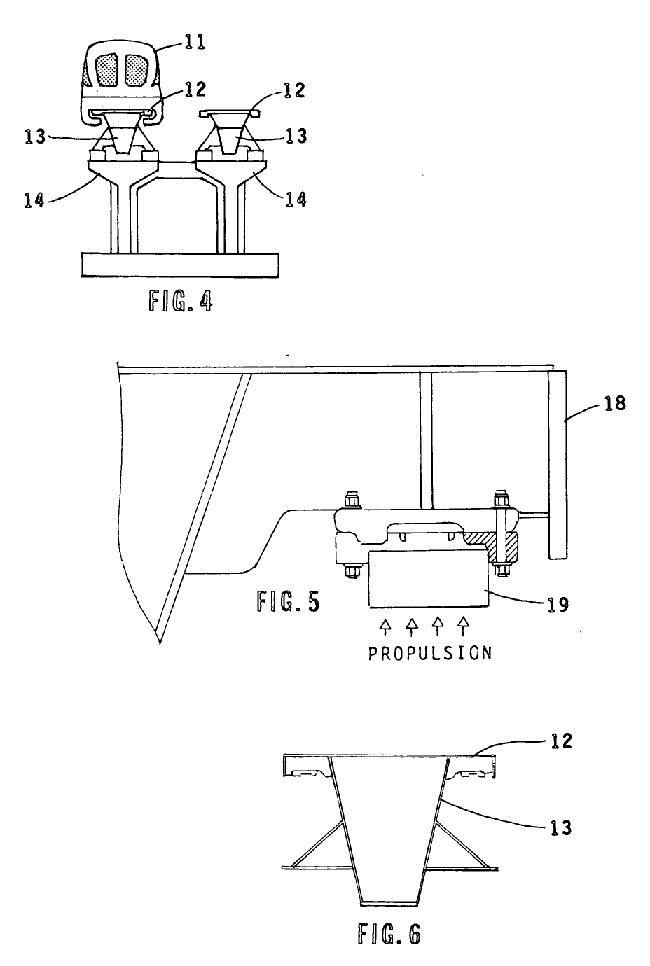

FIG. 4 illustrates a typical system including a train 11 magnetically supported on a functional element. The functional element is supported on structural element 13 which in turn is supported on pilings 14 in the ground.

1. A method for assembling a system employing magnetic levitators for a railroad support track installed in the ground comprising the steps of:
fabricating electromagnetic functional elements for said system;
fabricating structural elements for use in supporting the functional elements;
transporting said structural and functional elements separated from each other to the site of the support track;
installing said structural elements on the ground; and
attaching said functional elements to said structural elements for adjustment therebeteween both vertically and laterally.

2. The method of claim 1 wherein said elements are adjusted relative to each other so that they are parallel to each other and at the same height above the ground.

3. The method of claim 1 wherein said functional elements are fabricated to have a length of the order of 6-12 meters.

4. The method of claim 1 wherein the structural element is fabricated of concrete.

5. The method of claim 1 wherein the structural element is fabricated of metal.

6. A system employing electromagnetic levitation and drive for a railroad, said system having electromagnetic levitation and drive circuitry on the railroad and being electromagnetically supported on the ground, said system comprising:
electromagnetic functional elements having relatively short lengths which operate in conjunction with the circuitry on the railroad;
structural elements supported on the ground; and
means for adjustably attaching said functional and structural elements to each other at the site of the railroad for relative adjustment therebetween both vertically and laterally.

7. The system of claim 6 wherein said functional elements have a length of the order of 6-12 meters.

8. The system of claim 6 wherein said means for adjustably attaching each of said functional and structural elements to each other comprises a plurality of holes formed in said elements, a plurality of bolts, each of said bolts being fitted through one of the holes of each of said elements, the holes of one of said elements being longer and wider than the diameter of said bolts whereby said elements can be adjusted both vertically and laterally relative to each other and the bolts tightened to hold the elements together when they are aligned.

9. The system of claim 6 wherein said means for attaching each of said structural and functional elements to each other comprises at least one bracket. said bracket being attached to said functional and structural elements by means of at least one bolt for each such attachment, said brackets having a first aperture in a first portion thereof and a second aperture in a second portion thereof, said structural elements and said functional elements each having at least one aperture formed therein, the aperture in said functional element being elongated vertically, the aperture in the second portion of said bracket being oriented horizontally, a bolt fitted through the first aperture in said bracket and the vertically elongated aperture in said functional element, and a bolt fitted through the second aperture in said bracket whereby said functional and structural elements can be oriented vertically and laterally relative to each other retained in an optimum position by said bolts.
